(19) United States
(12) Patent Application Publication
(10) Pub. No.: US 2012/0328095 A1
(43) Pub. Date: Dec. 27, 2012

(54) IMAGE DECRYPTION APPARATUS AND IMAGE DECRYPTION METHOD

(75) Inventors: Jun Takahashi, Kawasaki (JP); Shohei Nakagata, Kawasaki (JP); Kensuke Kuraki, Ichikawa (JP); Taizo Anan, Kawasaki (JP)

(73) Assignee: FUJJITSU LIMITED, Kawasaki-shi (JP)

(21) Appl. No.: 13/605,285

(22) Filed: Sep. 6, 2012

Related U.S. Application Data
(63) Continuation of application No. PCT/JP2010/054030, filed on Mar. 10, 2010.

(51) Int. Cl. G06F 21/24

(52) U.S. Cl. 380/28

(57) ABSTRACT

An image decryption apparatus includes: an interface unit that acquires an encrypted image; and a processor adapted to: specify a block not presenting unevenness in brightness and a block presenting unevenness in brightness, among a plurality of first blocks into which the encrypted image is divided, and generate a decrypted image by moving each pixel of the encrypted image, in accordance with a predetermined rule; select, from among the second blocks located near the block of interest in a plurality of second blocks into which the decrypted image is divided, at least one second block that is included in the block not presenting unevenness in brightness on the encrypted image prior to generation of the decrypted image, as a reference value calculation block; and correcting the value of each pixel included in the block of interest, using the values of pixels included in the reference value calculation block.

### CROSS-REFERENCE TO RELATED APPLICATION

This application is a continuation application and is based upon PCT/JP2010/054030, filed on Mar. 10, 2010, the entire contents of which are incorporated herein by reference.

### FIELD

The embodiments discussed herein are related to an image decryption apparatus and an image decryption method for converting an encrypted image that is printed on a medium into electronic data, and then, decrypting the encrypted image represented by the electronic data.

### BACKGROUND

In recent years, techniques have been proposed for preventing confidential information that is contained in printed media from being leaked. In particular, techniques of encrypting an image, which one does not want an unspecified number of people to see, in advance, and printing that encrypted image on a medium such as paper have been proposed (see, for example, Japanese Laid-Open Patent Publication No. 2008-301044 and Japanese Laid-Open Patent Publication No. 2009-232129). An encryption apparatus to use one such technique switches the arrangement of the pixels contained in an encryption target area on an input image, in block units, in accordance with a predetermined encryption key. Furthermore, that encryption apparatus assigns positioning markers for specifying the encrypted area to at least two of the four corners of the encrypted area. Also, that encryption apparatus assigns a check marker for examining the relevance of the decrypted image to be acquired by decrypting the encrypted area. On the other hand, the decryption apparatus reads the medium on which the image having the encrypted area is printed, using a reading device such a scanner or a digital camera, and generates electronic data. Then, given the image having been converted into electronic data, the decryption apparatus acquires the original image by decrypting the encrypted area with reference to the positioning markers.

However, when a medium on which an image having an encrypted area is read by a digital camera and so on, depending on the angle of the digital camera or the lighting environment, unevenness in brightness may be produced in the encrypted area in the image converted into electronic data. In this case, when the decryption apparatus decrypts the encrypted area, the pixels included in the area where unevenness in brightness is produced are spread all over the image. Consequently, the brightness in the decrypted area varies per block, which is the unit when changing the positions of pixels, and therefore, compared to the original image, the image quality of the decrypted image is severely deteriorated.

### SUMMARY

According to one embodiment, an image decryption apparatus is provided. The image processing apparatus includes: an interface unit that acquires an encrypted image that is generated by switching each pixel of an original image, with another pixel of the original image, according to a predetermined rule to indicate a source of move and a destination of move per position conversion block; and a processor that generates a decrypted image by decrypting the encrypted image. This processor is adapted to implement: an unevenness detection function of dividing the encrypted image into a plurality of first blocks, and, among the plurality of first blocks, specifying a first block not presenting unevenness in brightness and a first block presenting unevenness in brightness; a decryption function of generating a decrypted image by moving each pixel of the encrypted image, from the destination of move to the source of move indicated in the predetermined rule per position conversion block; and a correction function of dividing the decrypted image into a plurality of second blocks, and, with respect to a block of interest among the plurality of second blocks, selecting, from among the second blocks located near the block of interest, a second block that is included in the first block not presenting unevenness in brightness on the encrypted image prior to generation of the decrypted image, as a reference value calculation block, and correcting a value of each pixel included in the block of interest, using values of pixels included in the reference value calculation block.

Also, according to another embodiment, an image decryption method is provided. This image decryption method includes: dividing an encrypted image, which is generated by switching each pixel of an original image, with another pixel of the original image, according to a predetermined rule to indicate a source of move and a destination of move per position conversion block, into a plurality of first blocks, and, among the plurality of first blocks, specifying a first block not presenting unevenness in brightness and a first block presenting unevenness in brightness; generating a decrypted image by moving each pixel of the encrypted image, from the destination of move to the source of move indicated in the predetermined rule per position conversion block; and dividing the decrypted image into a plurality of second blocks, and, with respect to a block of interest among the plurality of second blocks, selecting, from among the second blocks located near the block of interest, a second block that is included in the first block not presenting unevenness in brightness on the encrypted image prior to generation of the decrypted image, as a reference value calculation block; and correcting a value of each pixel included in the block of interest, using values of pixels included in the reference value calculation block.

Furthermore, according to yet another embodiment, a computer program to make a computer execute decryption of an encrypted image is provided. This computer program causes a computer to execute: dividing an encrypted image, which is generated by switching each pixel of an original image, with another pixel of the original image, according to a predetermined rule to indicate a source of move and a destination of move per position conversion block, into a plurality of first blocks, and, among the plurality of first blocks, specifying a first block not presenting unevenness in brightness and a first block presenting unevenness in brightness; generating a decrypted image by moving each pixel of the encrypted image, from the destination of move to the source of move indicated in the predetermined rule per position conversion block; and dividing the decrypted image into a plurality of second blocks, and, with respect to a block of interest among the plurality of second blocks, selecting, from among the second blocks located near the block of interest, a second block that is included in the first block not presenting unevenness in brightness on the encrypted image prior to generation of the decrypted image, as a reference value calculation block; and correcting a value of each pixel included in the block of interest, using values of pixels included in the reference value calculation block.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of an image decryption apparatus according to the first embodiment.

FIG. 2 is a diagram illustrating the relationship between the positions of position conversion blocks, in which an original image is divided, and the positions of position conversion blocks after a scrambling process.

FIG. 3A is a diagram illustrating an example of an encrypted image.

FIG. 3B is a diagram illustrating an example of an original image that is acquired by decrypting the encrypted image illustrated in FIG. 3A.

FIG. 3C is a diagram illustrating an example of an encrypted image in which unevenness is produced in brightness, given by reading a medium on which the encrypted image illustrated in FIG. 3A using a digital camera and so on.

FIG. 3D is a diagram illustrating an example of an original image that is acquired by decrypting the encrypted image illustrated in FIG. 3C according to prior art.

FIG. 4 is a block diagram illustrating the functions of processing units that are implemented to decrypt an encrypted image, according to the first embodiment.

FIG. 5 is a diagram illustrating an example of a histogram of pixel values with respect to each first block set for the encrypted image illustrated in FIG. 3A.

FIG. 6 is a diagram illustrating an example of a histogram of pixel values with respect to each first block set for the encrypted image illustrated in FIG. 3C.

FIG. 7 is an operation flowchart of an unevenness detection process by an unevenness detection unit, controlled by a computer program that is executed on a processing unit of an image decryption apparatus.

FIG. 8 is an operation flowchart of a pixel value correction process by a correction unit, controlled by a computer program that is executed on a processing unit of an image decryption apparatus.

FIG. 9 is a diagram illustrating examples of positions of a block of interest and its nearby blocks on a decrypted image, on an encrypted image before decryption.

FIG. 10 is an operation flowchart of an image decryption process according to the first embodiment, controlled by a computer program that is executed on a processing unit of an image decryption apparatus.

FIG. 11 is a block diagram illustrating the functions of processing units implemented to decrypt an encrypted image, according to a second embodiment.

FIG. 12 is an operation flowchart of an image decryption process according to a second embodiment, controlled by a computer program that is executed on a processing unit of an image decryption apparatus.

### DESCRIPTION OF EMBODIMENTS

An image decryption apparatus according to the first embodiment will be described below with reference to the accompanying drawings. This image decryption apparatus acquires a decrypted image, by decrypting an image that is encrypted and that is represented by electronic data acquired by reading the medium on which the encrypted image is printed, by means of a reading device. This image decryption apparatus divides the encrypted image into a plurality of first block units, and, among the plurality of first blocks, specifies the first blocks presenting unevenness in brightness and the first blocks not presenting unevenness in brightness. Then, this image decryption apparatus divides the decrypted image acquired by decrypting an encrypted image into second block units having a plurality of pixels, and finds the statistic of the pixel values of each second block. Then, this image decryption apparatus corrects the value of each pixel in a block of interest, such that the statistic of the pixel values of a second block of interest matches the statistic of the pixel values of a second block that is near the block of interest and that was included in the first blocks not presenting unevenness in brightness before decryption. Note that, in the present specification, an image that is encrypted will be simply referred to as “encrypted image.

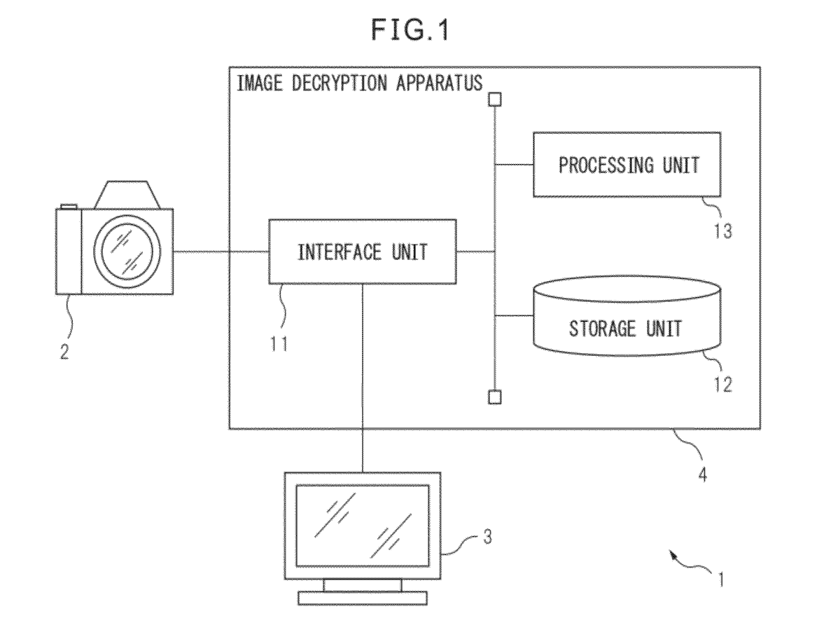

FIG. 1 is a schematic configuration diagram of an image decryption apparatus according to one embodiment. The image decryption apparatus 1 includes an interface unit 11, a storage unit 12 and a processing unit 13. Then, the image decryption apparatus 1 acquires a decrypted image, by executing a decryption process on an encrypted image converted into electronic data, which is acquired via the interface unit 11.

The interface unit 11 has a communication interface, and its control circuit, for connecting, for example, the image decryption apparatus 1, with an image input device 2, such as a digital camera, a mobile telephone with a camera and so on, and an output device 3, such as a display, a printer, etc. This communication interface may be an interface to comply with a communication standard such as, for example, the universal serial bus (USB), the small computer system interface (SCSI), and so on.

The image input device 2 photographs an encrypted image that is printed on a medium such as paper, and converts this encrypted image into electronic data. The interface unit 11 acquires the encrypted image converted into electronic data, from the image input device 2, and passes this encrypted image to the processing unit 13. Also, the interface unit 11 receives the decrypted image from the processing unit 13 and outputs that decrypted image to the output device 3.

Also, the interface unit 11 may have a communication interface, and its control circuit, for connecting with a communication network or complying with a communication standard such as Ethernet (registered trademark), or with the integrated services digital network (ISDN). Then, the image decryption apparatus 1 may transmit the decrypted image to other devices, via the interface unit 11.

The storage unit 12 has, for example, at least one of a semiconductor memory, a magnetic disk device and an optical disk device. Then, the storage unit 12 stores, for example, a computer program that is executed in the image decryption apparatus 1, parameters such as a decryption key to be used to decrypt an encrypted image, an encrypted image that is converted into electronic data acquired from the image input device 2, and a decrypted image that is generated by the processing unit 13.

The processing unit 13 has one or a plurality of processors and the peripheral circuits. Then, the processing unit 13 generates a decrypted image, by executing a decryption process upon an encrypted image converted into electronic data, acquired from the image input device 2. Furthermore, the processing unit 13 controls the entirety of the image decryption apparatus 1.

To help understand the decryption process executed by the processing unit 13, an example of the encryption process that is performed upon an original image will be described.

The encryption apparatus for executing the encryption process first divides the area to encrypt in the original image into a plurality of blocks, and assigns a unique number to each block. For example, the encryption apparatus divides the area to encrypt into 3 vertical blocks×4 horizontal blocks, twelve blocks in total, and assigns the numbers 1 to 12 to these blocks. Next, the encryption apparatus performs a scrambling process to rearrange the position of each block, using an encryption key. For this, from the encryption key, the encryption apparatus prepares a correspondence table to represent the position relationships of the blocks before conversion and after conversion. For example, assume that the number of a block after conversion is represented by x, and the number of a block before conversion is represented by y. Then, the block conversion algorithm corresponding to the scrambling process is represented by the following equation.

y=(px)mod q (Equation 1)

In equation (1), p and q are both prime numbers represented by the encryption key.

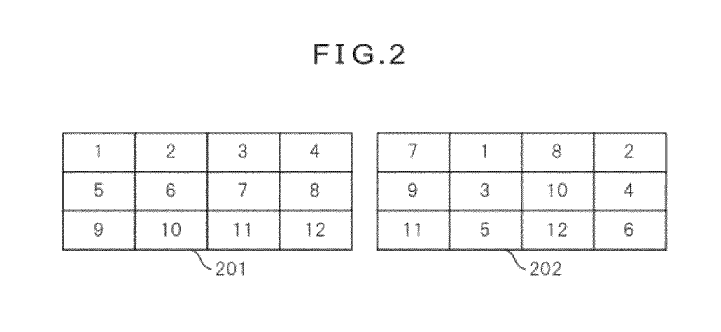

FIG. 2 illustrates the relationship between the position of each block on the original image and the position of each block on the image after the scrambling process, where the original image is divided into 3 vertical blocks×4 horizontal blocks and where p=7 and q=13. In FIG. 2, the image 201 is the original image and the image 202 is an encrypted image given by applying a scrambling process to the original image 201. Also the numbers illustrated in the blocks of the original image 201 and the encrypted image 202 are the numbers of the blocks in the original image. For example, from equation (1), when x is 1, the corresponding y value becomes 7. Consequently, the encryption apparatus moves the block where the block number y before conversion is 7, to the position of the block where the block number x after conversion is 1, by the scrambling process.

This block, which is the unit of moving the positions of pixels to other positions by the scrambling process, will be hereinafter referred to as “position conversion block”.

Note that the encryption apparatus may convert the value of a pixel in a predetermined position, such as the upper left edge in each position conversion block, so that the apparatus to execute the decryption process is able to detect the position of each position conversion block accurately (see, for example, the method described in Japanese Laid-Open Patent Publication No. 2009-232129). Furthermore, to allow the apparatus to execute the decryption process to detect the position of the encrypted area accurately, the encryption apparatus may assign a position detection pattern, which is determined in advance (for example, see the pattern illustrated in FIG. 16 of Japanese Laid-Open Patent Publication No. 2008-301044), to the four corners of the encrypted area.

If little noise is superimposed upon the encrypted image acquired in this way, the decrypted image that is acquired by decrypting that encrypted image by the decryption apparatus according to prior art is an image that is not much different from the original image. However, for example, when a medium on which an encrypted image is printed, is photographed by a digital camera or mobile telephone with a camera, unevenness in brightness may be produced on an encrypted image converted into electronic data.

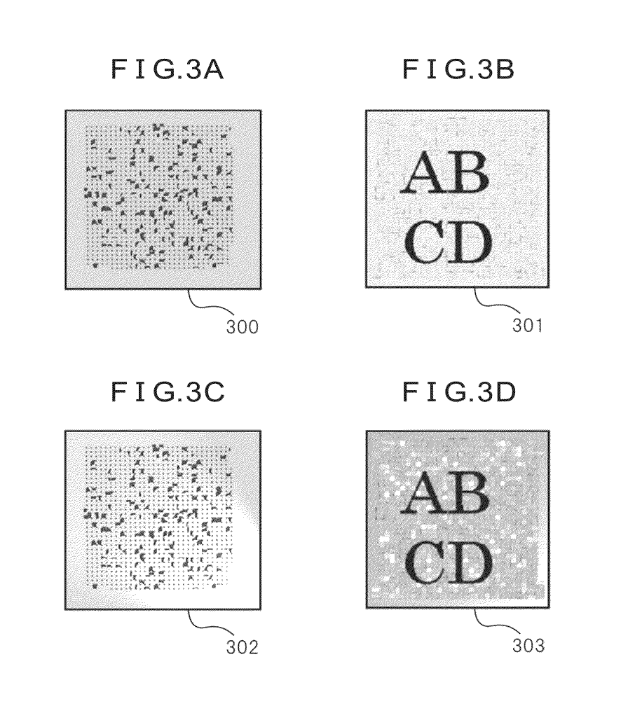

FIG. 3A is a diagram illustrating an example of an encrypted image 300. FIG. 3B is a diagram illustrating an example of a decrypted image 301 that is acquired by decrypting the encrypted image 300 illustrated in FIG. 3A. FIG. 3C is a diagram illustrating an example of an encrypted image 302 where unevenness in brightness is produced, by photographing the medium on which the encrypted image 300 illustrated in FIG. 3A is printed using a digital camera. FIG. 3D is a diagram illustrating an example of a decrypted image 303 that is acquired by decrypting the encrypted image 302 illustrated in FIG. 3C according to prior art.

As illustrated in FIG. 3A, unless there is not unevenness in brightness on the encrypted image 300, for example, the values of the pixels corresponding to the background part in the original image become uniform. Consequently, the values of the pixels of the background part become uniform in the decrypted image 301. As a result of this, the decrypted image 301 also has good image quality. However, as illustrated in FIG. 3C, in the encrypted image 302, the lower right part of the image becomes brighter than the other parts. As described above, in the encrypted image 302, compared to the original image, the positions of pixels in the image are switched, in position conversion block units, through the scrambling process upon encryption. Consequently, when the encrypted image 302 is decrypted, the pixels that are included in the lower right part of the encrypted image 302 move to various positions on the decrypted image 303. Consequently, bright pixels and dark pixels are mixed up in the decrypted image 303, and therefore the decrypted image 303 provides an image of low image quality, in which there is substantial noise compared to the original image.

Therefore, the processing unit 13 of the image decryption apparatus 1 according to this embodiment, after having decrypted the encrypted image converted into electronic data, received from the image input device 2, corrects the values of pixels in the decrypted image, using the values of pixels positioned in the area presenting no unevenness on the encrypted image.

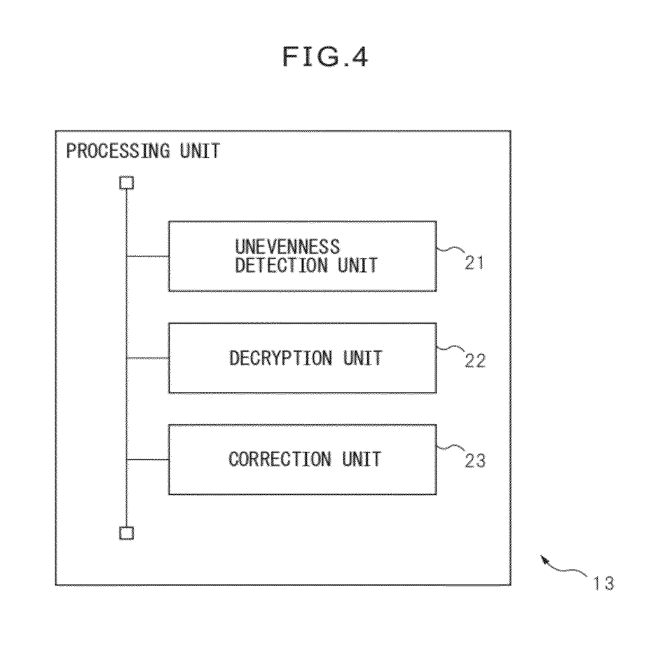

FIG. 4 is a block diagram illustrating the functions of a processing unit 13 that decrypts an encrypted image. The processing unit 13 has an unevenness detection unit 21, a decryption unit 22 and a correction unit 23. These units provided in the processing unit 13 are function modules that are implemented by a computer program that is executed on a processor provided in the processing unit 13.

Hereinafter, an encrypted image that is converted into electronic data will be simply referred to as “encrypted image,” unless there is an express indication that it is printed on a medium.

The unevenness detection unit 21 divides an encrypted image into a plurality of blocks, and, among the plurality of blocks, specifies the blocks presenting unevenness in brightness and the blocks not presenting unevenness in brightness.

In the encrypted image, by the scrambling process, information that is local on the original image is spread all over the image. Consequently, if noise is not superimposed upon the encrypted image, the statistic of pixel values in a block having a size to include a plurality of position conversion blocks in the encrypted image becomes substantially equal to the statistic of the pixel values of the entire encrypted image or the statistics of pixel values in other similar blocks. However, when the image input device 2 reads an encrypted image that is printed on a medium, if uneven brightness is superimposed upon part of the blocks in the encrypted image, the statistic of pixel values in this block, on which uneven brightness is superimposed, becomes significantly different from the statistic of pixel values in the entire encrypted image or the statistics of pixel values in other blocks. This circumstance will be described with reference to the accompanying drawings.

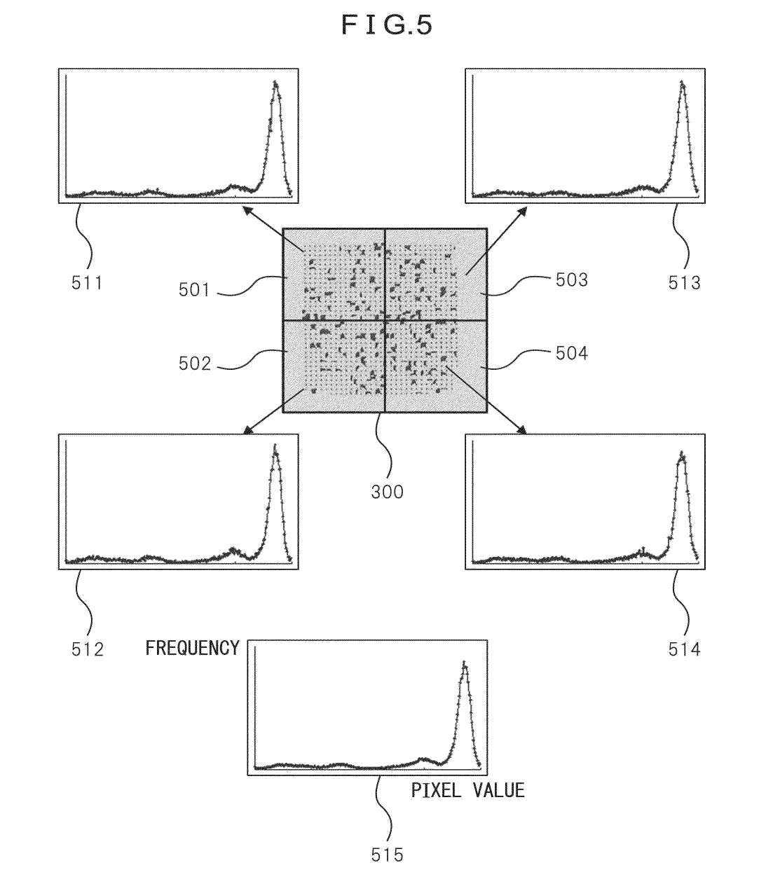

FIG. 5 is a diagram illustrating an example of a histogram of pixel values with respect to each block where the encrypted image 300 not presenting unevenness in brightness is divided into 2 vertical blocks×2 horizontal blocks. In FIG. 5, the encrypted image 300 is divided into an upper left block 501, a lower left block 502, an upper right block 503 and a lower right block 504. Then, the histograms 511 to 514 are the histograms of the values of the pixels included in the blocks 501 to 504, respectively. Also, the histogram 515 is a histogram of the pixel values of the entire encrypted image 300. In each histogram, the horizontal axis is the pixel value and the vertical axis is the frequency.

Since uneven brightness is not superimposed upon the encrypted image 300, the histograms 511 to 514, calculated with respect to the upper left, lower left, upper right and lower right blocks 501 to 504, have shapes that are substantially the same.

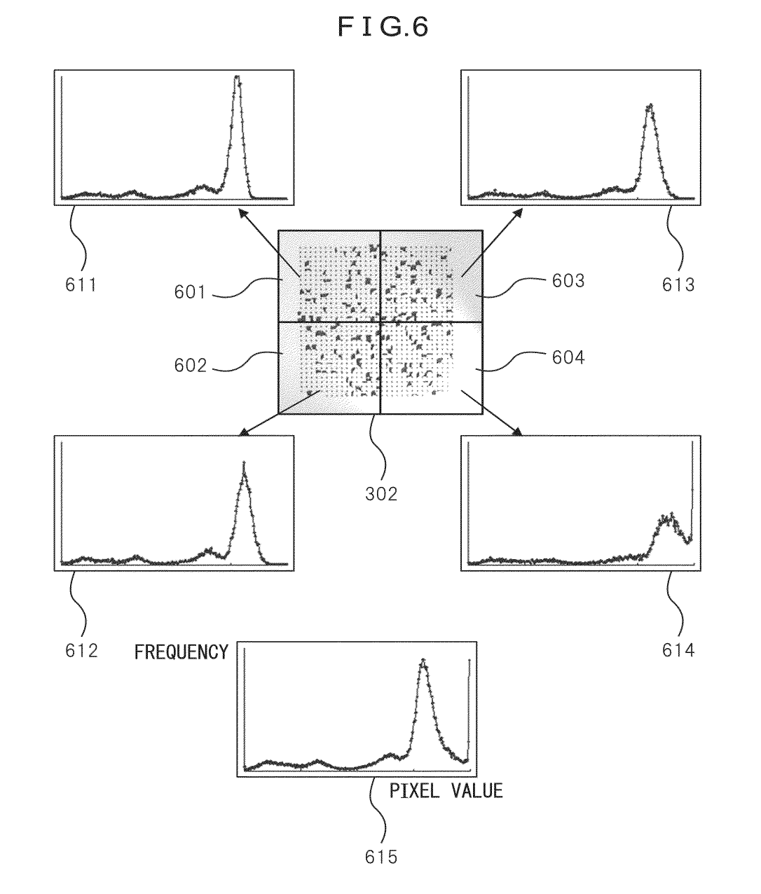

FIG. 6 is a diagram illustrating an example of a histogram of pixel values with respect to each block, where the encrypted image 302 presenting unevenness in brightness, illustrated in FIG. 3C, is divided into 2 vertical blocks×2 horizontal blocks. In FIG. 6, the encrypted image 302 is divided into an upper left block 601, a lower left block 602, an upper right block 603 and a lower right block 604. Then, the histograms 611 to 614 are the histograms of the values of the pixels included in the blocks 601 to 604, respectively. Also, the histogram 615 is a histogram of the pixel values of the entire encrypted image 302.

In this encrypted image 302, the nearer the lower right corner, the brighter. I.e., unevenness in brightness is produced in the lower right block 604. Consequently, in the histogram 614 for the lower right block 604, the frequency in high pixel values is higher than in the histograms for the other blocks. Consequently, the shape of the histogram 614 is significantly different from the shapes of the histograms of the other blocks or the histogram of the entire encrypted image 302.

Therefore, to detect a block presenting unevenness in brightness, for example, the unevenness detection unit 21 divides an encrypted image into a plurality of blocks, and compares the statistic of the values of the pixels included in each block, with the statistics of pixels values in the other blocks or the statistic of pixel values in the entire encrypted image.

Note that a block, which serves as the unit when the unevenness detection unit 21 determines whether or not there is unevenness in brightness, contains at least two position conversion blocks. Consequently, hereinafter, to distinguish between these blocks, a block to serve as the unit upon determining whether or not there is unevenness in brightness will be referred to as “large block.”

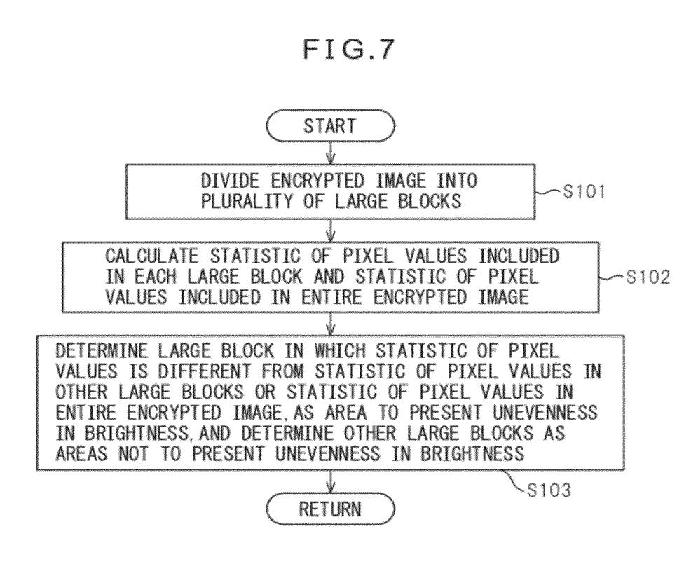

FIG. 7 is an operation flowchart of an unevenness detection process by an unevenness detection unit, controlled by a computer program that is executed on a processing unit in the image decryption apparatus.

The unevenness detection unit 21 divides an encrypted image into a plurality of large blocks (step S101). For example, the unevenness detection unit 21 divides an encrypted image into a plurality of large blocks of a predetermined size. For example, if an encrypted image has 640 vertical pixels×640 horizontal pixels and one large block has 160 vertical pixels×160 horizontal pixels, the unevenness detection unit 21 divides the encrypted image into 4 vertical×4 horizontal large blocks. Alternately, the unevenness detection unit 21 may divide an encrypted image such that the number of large blocks becomes a predetermined number (for example, 2 vertical×2 horizontal blocks, or 3 vertical×3 horizontal blocks).

Alternately, the unevenness detection unit 21 may dynamically determine the number of large blocks and the positions of individual large blocks to be set on an encrypted image, based on the resolution of the encrypted image or the histogram of the pixel values of the encrypted image. For example, in the cases where the number of divisions of an encrypted image is determined based on the resolution of the encrypted image, the unevenness detection unit 21 may determine the number of divisions, such that the size of the encrypted image printed on a medium, included in each individual large block, is the same. For example, the number into which an encrypted image read at a resolution of 200 dpi is divided in the vertical direction and the horizontal direction, may be twice the number into which an encrypted image read at a resolution of 100 dpi is divided in the vertical direction and the horizontal direction.

Also, in the cases where the number of divisions of an encrypted image is determined based on a histogram of the pixel values of the encrypted image, the unevenness detection unit 21 may determine that number of divisions, such that the number of pixels to have values equal to or lower than a predetermined threshold value and to be included in one large block, is equal to or greater than a certain number. For example, assume that, like when the original image is an image photographing a document, the pixels contained in an encrypted image can be roughly classified into black pixels (i.e., pixels that have low pixel values) and white pixels (i.e., pixels that have high pixel values). In this case, the unevenness detection unit 21 determines the number of divisions of an encrypted image such that the number of black pixels to be included in one large block is equal to or greater than a certain number. Note that the unevenness detection unit 21 may make a pixel having a pixel value lower than a predetermined threshold value a black pixel. For example, the predetermined threshold value may be an average value of the pixel values over the entire encrypted image or may be ½ of the maximum value which the pixel values can take. Then, the unevenness detection unit 21 finds the proportion of black pixels against the entire encrypted image, and makes the number of divisions smaller when the proportion is lower. For example, when the proportion of black pixels against the entire encrypted image is equal to or greater than a predetermined threshold value Th1, the unevenness detection unit 21 divides the encrypted image into 4 vertical blocks×4 horizontal blocks, and, on the other hand, when the proportion is lower than the threshold value Th1, divides the encrypted image into 3 vertical blocks×3 horizontal blocks. Also, the threshold value Th1 is set to the value that is given by dividing the desired number of black pixels to be included in one large block by the number of pixels to be included in one large block when an encrypted image is divided into 4 vertical blocks×4 horizontal blocks.

White pixels inherently have high pixel values. Consequently, when an encrypted image that is printed on a medium is read, if part of that encrypted image is illuminated by intense light, on the encrypted image converted into electronic data, the pixel values of the white pixels included in that part illuminated by that light may become the maximum pixel value. Consequently, if a large block corresponding to the part illuminated by the light contains only white blocks, the variation of the statistic of the pixel values in that large block due to the local illumination by the light may be little, and there is a possibility that the unevenness detection unit 21 is unable to accurately determine whether or not unevenness in brightness is produced. However, if the part illuminated by the light includes a plurality of black pixels, the pixel values of the black pixels vary significantly due to the illumination by the light. Consequently, the statistic of pixel values in a large block corresponding to the part illuminated by the light varies significantly from the statistic of pixel values as of when light is not illuminated. Therefore, as described above, the unevenness detection unit 21 is able to accurately determine whether or not there is unevenness in brightness, by determining the number of divisions such that each large block includes a certain number of black pixels or more.

Note that the unevenness detection unit 21 may determine the number of divisions of an encrypted image such that each large block includes a certain number of white pixels or more.

Next, for each large block, the unevenness detection unit 21 finds the statistic of the values of the pixels contained in that large block. Also, the unevenness detection unit 21 finds the statistic of the values of the pixels included in the entire encrypted image (step S102). With the present embodiment, the unevenness detection unit 21 finds, as a statistic of pixel values, a normalized histogram of pixel values that is acquired by dividing the appearance frequency of each individual pixel value by the total number of pixels included in a large block or in the entire encrypted image.

The unevenness detection unit 21 determines a large block, in which the statistic of the pixel values is different from the statistics of pixel values in other large blocks or the statistic of pixel values in the entire encrypted image, to be a block presenting unevenness in brightness, and determines the other large blocks to be blocks not presenting unevenness in brightness (step S103).

For example, assuming that the pixel values range from 0 to 255, a normalized histogram of an entire encrypted image is f(i) with respect to the pixel value i, and a normalized histogram of a large block of interest is g(i) with respect to the pixel value i, a convolution value h(t), which represents the degree of difference between the two normalized histograms, is calculated according to the following equation:

$$h ( t ) = {\sum }_{i = 0}^{255} \vert f ( i ) - g ( i - t ) \vert \qquad ( Equation 2 )$$

Note that t is the pixel value offset between the two histograms. From equation (2), h(t) has a value equal to or greater than 0. The unevenness detection unit 21 finds the minimum value of h(t), hmin, by calculating h(t) according to equation (2) while changing t variously. Then, when the absolute value of tmin, which is the shift amount of pixel values when the convolution value h(t) becomes the minimum value hmin, is lower than a predetermined threshold value Th2, the unevenness detection unit 21 determines that normalized histogram of a large block of interest resembles the normalized histogram of the entire encrypted image. Consequently, the unevenness detection unit 21 determines that the large block of interest is a block not presenting unevenness in brightness. On the other hand, when the absolute value of tmin is equal to greater than the threshold value Th2, the normalized histogram of the large block of interest is determined not to resemble the normalized histogram of the entire encrypted image. Consequently, the unevenness detection unit 21 determines the large block of interest to be a block presenting unevenness in brightness. Note that, in the cases where the encrypted image electronically converted by the image input device 2 has 256 tones, the threshold value Th2 is set, for example, to 30.

Also, the unevenness detection unit 21 may determine whether or not the large block of interest matches a block to present unevenness in brightness, based on hmin, instead of tmin.

In this case, for example, if hmin is lower than a predetermined threshold value Th3, the unevenness detection unit 21 may determine that the large block of interest is a block not presenting unevenness in brightness, and, on the other hand, if hmin is equal to or greater than the predetermined threshold value Th3, determines that the large block of interest is a block presenting unevenness in brightness. The predetermined threshold value Th3 is set, for example, to 0.3.

Also, the unevenness detection unit 21 may specify a block presenting unevenness in brightness by comparing the statistics of pixel values between large blocks. In this case, the unevenness detection unit 21 finds the minimum value hmin of the convolution values between the normalized histogram of the pixel values of the large block of interest and the normalized histograms of the pixel values of the other large blocks, and the amount of shift tmin of pixel values corresponding to this hmin. Then, the unevenness detection unit 21 finds the number of large blocks where the absolute value of tmin is equal to or greater than the threshold value Th2, or the number of large blocks where hmin is equal to or greater than the threshold value Th3, as the number of differing blocks of the large block of interest.

As described above, the statistics of the pixel values of two large blocks not presenting unevenness in brightness are substantially equal. Therefore, the unevenness detection unit 21 calculates the number of differing blocks with respect to all large blocks, and specifies the large block where the number of differing blocks is the minimum. The large block where the number of differing blocks is the minimum is estimated not to present unevenness in brightness. So, the unevenness detection unit 21 estimates the unevenness in brightness using the large block where the number of differing blocks is the minimum. The unevenness detection unit 21 determines a large block where the minimum value hmin of the convolution values with the large block having the minimum number of differing blocks is equal to or greater than the threshold value Th3, to be a block presenting unevenness in brightness. Also, the unevenness detection unit 21 may determine a large block where the absolute value of the shift amount tmin of pixel values corresponding to hmin is equal to or greater than the threshold value Th2 as a block presenting unevenness in brightness. On the other hand, the unevenness detection unit 21 determines a large block where the minimum value hmin of the convolution values with the large block having the minimum number of differing blocks is lower than the threshold value Th3, to be a block not presenting unevenness in brightness. Also, the unevenness detection unit 21 may determine a large block where the absolute value of the shift amount tmin of pixel values corresponding to hmin is lower than the threshold value Th2 as a block not presenting unevenness in brightness.

Note that the unevenness detection unit 21 may find the reliability to represent the reliability of each large block as to the absence of uneven brightness. In this case, the unevenness detection unit 21 is able to calculate the reliability P of the large block of interest according to, for example, the following equation:

P=(255−|tₘᵢₙ|)/255 (Equation 3)

The value of the reliability P ranges from 0 to 1. Then, when the value of the reliability P is higher, this means that the possibility that the large block of interest does not present unevenness in brightness is higher.

Furthermore, the unevenness detection unit 21 may find the average value, median, mode, variance, and the maximum value and the minimum value of the pixel values in an encrypted image or a large block, as the statistics of pixel values, instead of normalized histograms. Then, the unevenness detection unit 21 may determine whether or not blocks present unevenness in brightness, on a per large block basis, by comparing one or two of these statistics calculated with respect to a large block of interest, with the statistics of the of the same kind calculated with respect to the entire encrypted image or other large blocks.

The unevenness detection unit 21 sets unevenness detection flag which represents whether or not there is unevenness in brightness, per large block. For example, for a large block that is determined not to present unevenness in brightness, the unevenness detection flag is set to “OK”, and, for a large block that is determined to present unevenness in brightness, the unevenness detection flag is set to “NG”. Then, the unevenness detection unit 21 reports information to represent the position and range of each large block, and the corresponding unevenness detection flag, to the decryption unit 22 and the correction unit 23. Also, in the cases where reliability is calculated on a per large block basis, the unevenness detection unit 21 reports the reliabilities to the decryption unit 22 and the correction unit 23, instead of unevenness detection flags.

Note that, in the cases where a position detection pattern to indicate the position of an encrypted area is assigned to an encrypted image, the unevenness detection unit 21 may specify the encrypted area, from the encrypted image converted into electronic data, by, for example, detecting the position detection pattern by means of template pattern matching using a template corresponding to that position detection pattern, and divide that encrypted area into a plurality of large blocks.

The decryption unit 22 generates a decrypted image by executing the decryption process on the encrypted image. To be more specific, the decryption unit 22 executes a descrambling process of the encrypted image. The decryption unit 22 is able to determine the original position y of a position conversion block in the encrypted image, where the position of the position conversion block after the scrambling process is executed is x, based on equation (1) that converts the positions of position conversion blocks and the encryption key used upon execution of the scrambling process. Then, by moving each position conversion block in the encrypted image to the acquired original position of that position conversion block, the decryption unit 22 is able to generate a decrypted image in which the positions of the position conversion blocks are the same as their positions in the original image.

Note that the decryption unit 22 may execute the following processes before executing the descrambling process.
In the cases where a position detection pattern to indicate the position of an encrypted area is assigned to an encrypted image, for example, the decryption unit 22 specifies the encrypted area by detecting the position detection pattern by means of template matching using a template corresponding to that position detection pattern.
In the cases where, in an encrypted image, the values of part of the pixels in each position conversion block are converted, the decryption unit 22 detects each position conversion block by detecting those converted pixels.

Furthermore, the decryption unit 22 specifies the large block, to which each position conversion block belonged before the descrambling process. Then, for each position conversion block, the decryption unit 22 associates the unevenness detection flag or reliability with respect to the large block to which that position conversion block belonged, with that position conversion block.

The decryption unit 22 passes the decrypted image, and the unevenness detection flags or reliabilities with respect to the position conversion blocks on that decrypted image, to the correction unit 23.

The correction unit 23 divides the decrypted image into a plurality of blocks, where a block is the unit upon correcting the pixel values. Then, the correction unit 23 corrects the value of each pixel in the decrypted image, on a per block basis, based on the statistic of each block in the decrypted image and based on whether or not there is unevenness of brightness in the large block to which that block belonged in the encrypted image.

Note that this block, which serves as the unit of pixel value correction, is smaller than a large block, which serves as the unit upon determining whether or not there is unevenness in brightness. Hereinafter, this unit block in pixel value correction will be referred to as “small block,” for ease of explanation. Each small block may preferably be a position conversion block, to simplify the process. Alternately, a small block may be smaller than a position conversion block.

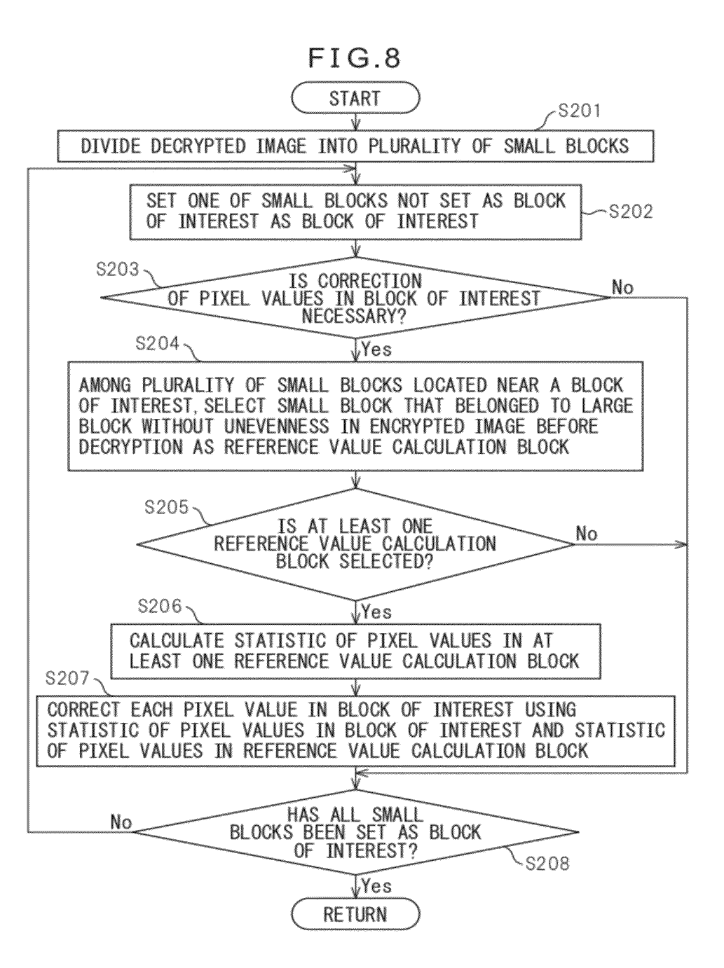

FIG. 8 is an operation flowchart of the pixel value correction process by the correction unit 23, controlled by a computer program that is executed on a processing unit of an image decryption apparatus.

The correction unit 23 divides the decrypted image into a plurality of small blocks (step S201). After that, the correction unit 23 sets a given small block that is not set as a block of interest in decrypted image, as a block of interest (step S202).

The correction unit 23 determines whether or not the pixel values in the block of interest need to be corrected (step S203). For example, the correction unit 23 calculates statistics which might serves as the reference upon correcting the pixel values, per small block. AS such statistics, the correction unit 23 calculates, for example, the maximum value and the minimum value of the pixel values in a small block. Also, the correction unit 23 may calculate the average value and variance of the pixel values in a small block, as statistics.

Then, when the statistic in a block of interest and the statistic of each small block neighboring that block of interest are equal, or when all the pixel values in the block of interest are equal, the correction unit 23 determines that the pixel values in the block of interest do not need to be corrected. Alternately, when the block of interest belonged to a large block not presenting unevenness in the encrypted image before decryption, the correction unit 23 may determine that the pixel values in the block of interest do not need to be corrected.

When it is determined that the pixel values in the block of interest need to be corrected (step S203—Yes), the correction unit 23 selects a small block that belonged to a large block not presenting unevenness on the encrypted image before decryption, among a plurality of small blocks positioned near the block of interest, as a reference value calculation block (step S204). Note that the small blocks positioned near the block of interest include, for example, four small blocks near the block of interest—i.e., the small blocks that neighbor the block of interest from the left, right, above and below. Also, the small blocks positioned near the block of interest may include eight small blocks near the block of interest—i.e., the above four nearby small blocks plus small blocks that neighbor the block of interest in oblique directions with respect to the block of interest. Also, the small blocks positioned near the block of interest may include twenty four small blocks near the block of interest—i.e., the small blocks included within a distance of two blocks from the block of interest.

The correction unit 23 may reference, for each small block, the unevenness detection flag or reliability associated with the position conversion block which that small block is included in or is identical to. By this means, the correction unit 23 is able to determine whether or not each small block belonged to a large block not presenting unevenness prior to the decryption of the encrypted image.

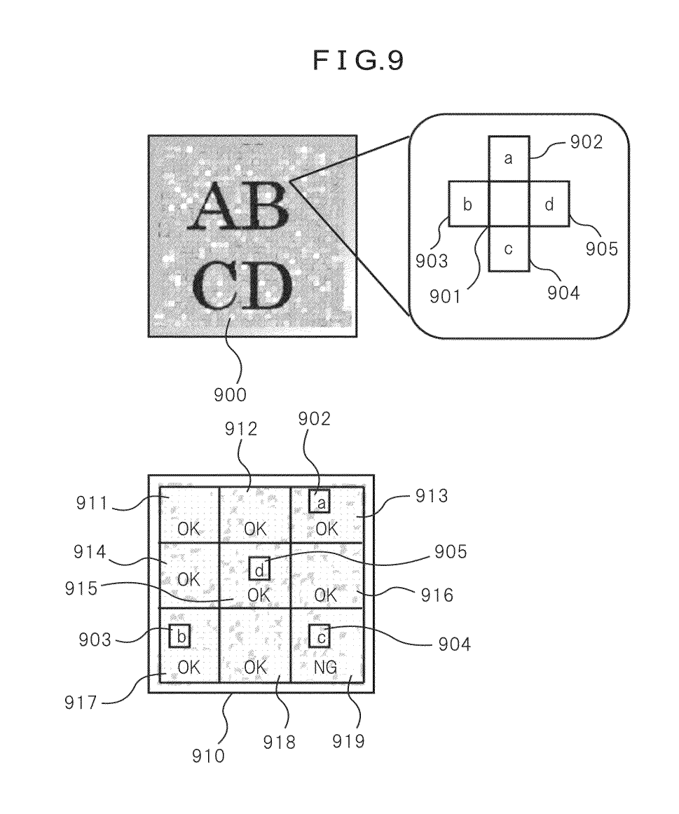

FIG. 9 is a diagram illustrating an example of the relationship between a block of interest and its four nearby small blocks, and the large blocks in which these small blocks were included prior to execution of the descrambling process. In FIG. 9, the image 900 is a decrypted image that is generated by the decryption unit 22. Then, the small block 901, which is displayed enlarged on the right side of the decrypted image 900, represents a block of interest, including pixels of which values are to be corrected. Also, the small blocks 902 to 905 are four small blocks near the small block 901. Also, the image 910 is an encrypted image that corresponds to the decrypted image 900. In the encrypted image 910, nine large blocks 911 to 919 are set. Then, the small blocks 902 to 905 are included in the large blocks 913, 917, 919 and 915, before execution of the descrambling process.

In this case, assume that the large blocks 911 to 918 do not present unevenness in brightness, while the large block 919 presents unevenness in brightness. Consequently, the large blocks 911 to 918 are each assigned an unevenness detection flag that says “OK”, while the large block 919 is assigned an unevenness detection flag that says “NG”. In this case, the small blocks 902, 903 and 905 are included in large blocks not presenting unevenness in brightness. However, the small block 904 is included in a large block presenting unevenness in brightness. Consequently, amongst the small blocks 902 to 905, the small blocks 902, 903 and 905 are selected as reference value calculation blocks.

Also, in the cases where the reliability is found for each small block, instead of using the unevenness detection flag, the correction unit 23 may select a small block having a reliability that is higher than a predetermined threshold value, among the small blocks positioned near the block of interest, as a reference value calculation block. Note that the threshold value is set, for example, to 0.5.

Referring back to FIG. 8, after step S204, the correction unit 23 determines whether or not at least one reference value calculation block has been selected (S205). When no reference value calculation block has been selected—i.e., when all the small blocks near the block of interest belonged to large blocks presenting unevenness in brightness in the encrypted image before decryption (step S205—No), the correction unit 23 is unable to find accurate correction values. Consequently, the correction unit 23 does not correct the pixel values in the block of interest. Then, the correction unit 23 executes the processes of and after step S208.

On the other hand, when at least one reference value calculation block is selected (step S205—Yes), the correction unit 23 calculates the statistic of pixel values in at least one reference value calculation block, which serves as the reference upon determining the correction values of the pixel values in the block of interest (step S 206). For example, in the cases where the maximum value and the minimum value of the pixel values in the block of interest are calculated as statistics of the pixel values in that block of interest in the correction unit 23, the correction unit 23 may find the maximum value and the minimum value of pixel values in at least one reference value calculation block. Alternately, when the average value and variance value of the pixel values in the block of interest are calculated as statistics of the pixel values in that block of interest in the correction unit 23, the correction unit 23 may find the average value and variance value of pixel values in at least one reference value calculation block.

The correction unit 23 corrects each pixel value in the block of interest using the statistic of the pixel values in the block of interest and the statistic of the pixel values in the reference value calculation block (step S207). For example, the maximum value and the minimum value of the pixel values in the block of interest are referred to as smax and smin, respectively, and the maximum value and the minimum value of the pixel values in the reference value calculation block are referred to as qmax and qmin, respectively. In this case, the correction unit 23 corrects the value of each pixel in the block of interest according to the following equation:

$${s}^{′} = \frac{{q}_{m ax} - {q}_{m i n}}{{s}_{m ax} - {s}_{m i n}} ( s - {s}_{m i n} ) + {q}_{m i n} \\ ( {s}_{m ax} > {s}_{ m i n} , {q}_{m ax} > {q}_{m i n} • ) \qquad ( Equation 4 )$$

s is the value of a specific pixel in the block of interest before correction, and s′ is the value of that pixel after correction.

Also, the correction unit 23 may correct the value of each pixel in the block of interest such that the average value and variance of the pixel values in the block of interest are equal to the average value and variance of the pixel values in the reference value calculation block.

After step S207, or when no reference value calculation block is selected in step S205, the correction unit 23 determines whether or not all the small blocks are set in the block of interest. Also, when, in step S203, it is determined that the pixel values in the block of interest do not need to be corrected, the correction unit 23 determines whether all the small blocks has been set as the block of interest (step S208). When there is a small block that is not set in the block of interest (step S208—No), the correction unit 23 repeats the processes of steps S202 to S208. On the other hand, when all the small blocks are set in the block of interest, the correction unit 23 finishes the brightness correction process.

The processing unit 13 outputs the decrypted image to the output device 3 via the interface unit 11. Also, the processing unit 13 may store the decrypted image in the storage unit 12.

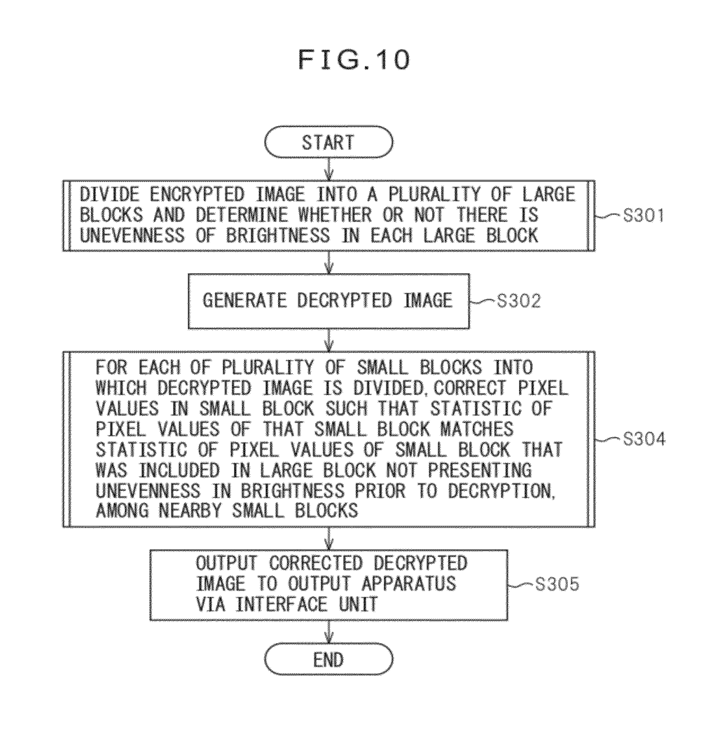

FIG. 10 is an operation flowchart of the image decryption process, controlled by a computer program that is executed on the processing unit 13 of the image decryption apparatus 1.

First, an encrypted image that is printed on a medium is read by the image input device 2, and the encrypted image is converted into electronic data. When the image decryption apparatus 1 receives this encrypted image converted into electronic data, the processing unit 13 starts the image decryption process. Then, the unevenness detection unit 21 in the processing unit 13 divides the encrypted image into a plurality of large blocks and determines, for each large block, whether or not there is unevenness in brightness (step S301). Then, the unevenness detection unit 21 reports information to represent the positions and ranges of the large blocks, and unevenness detection flags to represent the results of determining whether or not there is unevenness in brightness in the large blocks, to the decryption unit 22 and the correction unit 23. Also, in the cases where reliability is calculated on a per large block basis, the unevenness detection unit 21 reports the reliabilities to the decryption unit 22 and the correction unit 23, instead of using unevenness detection flags.

The decryption unit 22 generates a decrypted image by executing the descrambling process of the encrypted image (step S302). Then, the decryption unit 22 passes the decrypted image to the correction unit 23 of the processing unit 13. Also, for each position conversion block on the decrypted image, the decryption unit 22 passes the unevenness detection flag or reliability with respect to the large block in which that block was included before decryption, to the correction unit 23.

The correction unit 23 divides the decrypted image into a plurality of small blocks. For each small block, the correction unit 23 selects, from among the nearby small blocks, a small block that was included in a large block not presenting unevenness in brightness before decryption, as a reference value calculation block. Then, the correction unit 23 corrects the values of pixel values in a small block such that statistic of pixel value in that small block matches the statistic of pixel value in the reference value calculation block (step S303).

The processing unit 13 outputs the corrected decrypted image to the output device 3 via the interface unit 11 (step S304). Alternately, the processing unit 13 stores the corrected decrypted image in the storage unit 12. Then, the processing unit 13 finishes the decryption process.

As described above, the image decryption apparatus according to the first embodiment generates a decrypted image by performing a descrambling process of an encrypted image converted into electronic data, which is acquired by reading an encrypted image printed on a medium and encrypted through a scrambling process. Upon doing this, this image decryption apparatus corrects the values of pixels included in a small block of interest on the decrypted image, using a statistic of pixel values in a small block which was included in a large block not presenting unevenness in brightness before execution of the descrambling process, among other small blocks positioned near the small block of interest. Consequently, when this image decryption apparatus reads an encrypted image that is printed on a medium, even if unevenness in brightness is produced on the encrypted image, the image decryption apparatus is able to alleviate the degradation of the image quality of the decrypted image due to that unevenness in brightness.

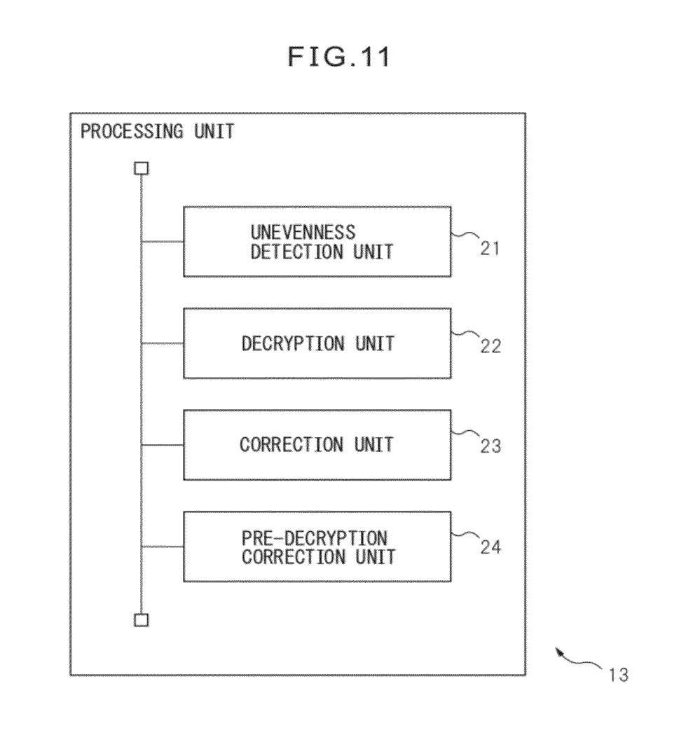

Next, an image decryption apparatus according to the second embodiment will be described in detail. FIG. 11 is a function block diagram of the processing unit 13 according to the second embodiment. As illustrated in FIG. 11, the processing unit 13 includes an unevenness detection unit 21, a decryption unit 22, a correction unit 23 and a pre-decryption correction unit 24. Note that, in FIG. 11, the function blocks of the processing unit 13 are assigned the same reference numerals as the corresponding function blocks of the processing unit 13 illustrated in FIG. 3.

Compared to the image decryption apparatus of the first embodiment, the image decryption apparatus according to the second embodiment is different in that the pre-decryption correction unit 24 corrects unevenness in brightness for an encrypted image that is converted into electronic data and that is not yet decrypted. So, the pre-decryption correction unit 24 will be described below.

For a plurality of large blocks, which an encrypted image converted into electronic data is divided into by the unevenness detection unit 21, the pre-decryption correction unit 24 corrects the pixel values included in the large blocks, based on the statistic of the values of the pixels included in a large block that is determined not to present unevenness in brightness. As described above, the encrypted image includes a plurality of position conversion blocks, where each position conversion block serves as the unit upon moving pixels in the scrambling process. Consequently, unless there is no unevenness in brightness, the statistics of pixel values calculated with respect to the individual large blocks become substantially equal.

The pre-decryption correction unit 24 corrects the values of pixels included in each large block, such that the statics of the pixel values of the individual large blocks become equal. Note that, if there is no unevenness in brightness, the statistics of pixel values calculated with respect to the individual large blocks become substantially equal, so that the large block to serve as the reference upon calculating correction values does not have to neighbor the large block of the target of pixel value correction.

For example, as the statistic of the pixel values of each large block, when the maximum value and the minimum value of the pixel values included in that large block are calculated, the pre-decryption correction unit 24 is able to determine the pixel values after correction using equation (4). Note that, in equation (4), if the pixel values of all large block are used as reference values, the maximum value and the minimum value of the pixel values included in the large block in which the pixel values are to be corrected, are smax and smin, respectively, and the maximum value and the minimum value of the pixel values included in all of the large blocks are qmax and qmin, respectively. s is the value of a pixel before correction, and s′ is the value of that pixel after correction.

In addition, since the unevenness detection unit 21 has detected whether or not there is unevenness in brightness in each large block, the pre-decryption correction unit 24 is able to apply the correction of pixel values only to large blocks presenting unevenness in brightness. In this case, a pixel value in a large block not presenting unevenness in brightness is used as a reference value, and, referring to equation (4), the maximum value and the minimum value of the pixel values in a large block which presents unevenness in brightness and in which the pixel values are to be corrected, are smax and smin, respectively, and the maximum value and the minimum value in a large block not presenting unevenness in brightness are qmax and qmin, respectively.

Also, the pre-decryption correction unit 24 may correct the value of each pixel in a large block such that the average value and variance of the pixel values of the large block become equal.

In addition, the unevenness detection unit 21 may find the reliability to represent the reliability of each large block as to the absence of uneven brightness. In this case, the pre-decryption correction unit 24 may correct the pixel values in a large block where the reliability is lower than a predetermined threshold value Tha such that the statistic of the pixel values of that large block becomes equal to the statistic of the pixel values of a large block where the reliability is higher than a predetermined threshold value Thb. The predetermined threshold value Tha can be set to, for example, 0.5. Also, the predetermined threshold value Thb is set to a value equal to or greater than Tha, for example, 0.8.

The pre-decryption correction unit 24 passes the corrected encrypted image to the decryption unit 22. Then, the decryption unit 22 generates a decrypted image by executing a decryption process upon the encrypted image having been corrected by the pre-decryption correction unit 24. This decrypted image will be referred to as “firs-corrected decrypted image” hereinafter. The correction unit 23 executes the processes having been described with respect to the first embodiment, based on the firs-corrected decrypted image.

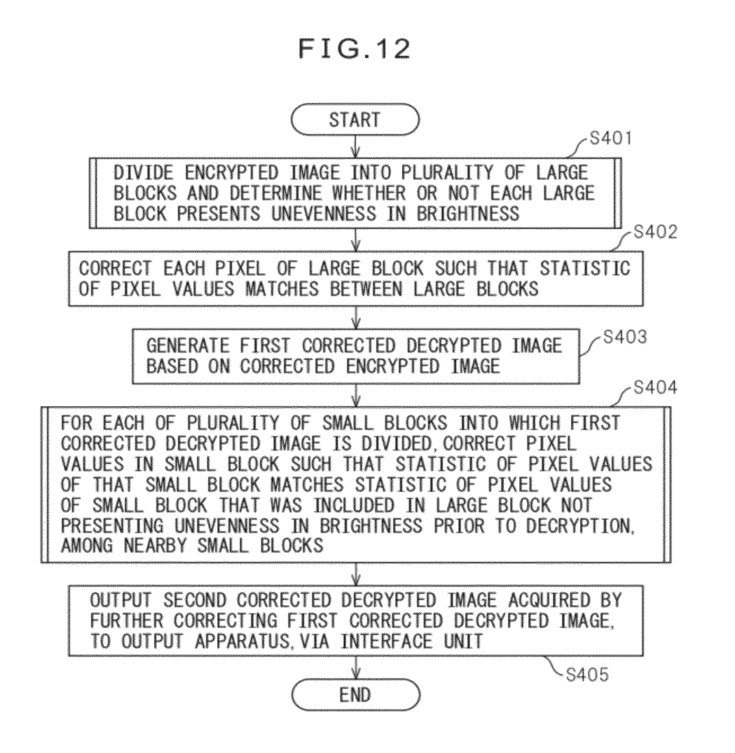

FIG. 12 is an operation flowchart of an image decryption process, controlled by a computer program that is executed on the processing unit 13 of the image decryption apparatus according to the second embodiment.

When the processing unit 13 starts the image decryption process, the unevenness detection unit 21 of the processing unit 13 divides an encrypted image that is converted into electronic data, into a plurality of large blocks, and determines whether or not there is unevenness in brightness in each large block (step S401). The unevenness detection unit 21 reports information to represent the positions and ranges of the large blocks and the determined results as to whether or not there is unevenness in brightness in each large block, to the pre-decryption correction unit 24, the decryption unit 22 and the correction unit 23 of the processing unit 13. In the cases where the reliability is calculated on a per large block basis, the unevenness detection unit 21 may report the reliabilities to the pre-decryption correction unit 24, the decryption unit 22 and the correction unit 23, instead of the unevenness detection flags.

The pre-decryption correction unit 24 corrects the values of pixels included in a large block set in the encrypted image converted into electronic data. To be more specific, as described earlier, the pre-decryption correction unit 24 corrects the value of each pixel in a large block such that the statistic of pixel values matches between the large blocks into which the encrypted image is divided (step S402). Then, the pre-decryption correction unit 24 passes the corrected encrypted image to the decryption unit 22.

Based on the corrected encrypted image, the decryption unit 22 generates the firs-corrected decrypted image (step S403). Then, the decryption unit 22 passes the firs-corrected decrypted image to the correction unit 23 of the processing unit 13. Also, the decryption unit 22 passes the unevenness detection flag or reliability of each block on the decrypted image, to the correction unit 23.

The correction unit 23 divides the firs-corrected decrypted image into a plurality of small blocks. For each small block, among its nearby small blocks, the correction unit 23 selects a small block which was included in a large block without unevenness in brightness before decryption, as a reference value calculation block. Then, the correction unit 23 corrects the pixel values in the small block such that the statistic of the pixel value in that small block matches the statistic of the pixel values in the reference value calculation block (step S404).

The processing unit 13 outputs the second corrected decrypted image that is acquired as the correction unit 23 corrects the firs-corrected decrypted image, to the output device 3, via the interface unit 11 (step S405). Alternately, the processing unit 13 stores the second corrected decrypted image in the storage unit 12. Then, the processing unit 13 finishes the decryption process.

As described above, the image decryption apparatus according to the second embodiment corrects unevenness in brightness, before performing a descrambling process of an encrypted image converted into electronic data, which is acquired by reading an encrypted image printed on a medium. Then, after having executed the decryption process, this image decryption apparatus executes the process of correcting unevenness in brightness again. In this way, this image decryption apparatus performs the process of correcting unevenness in brightness in two steps, so that it is possible to further alleviate the degradation of the image quality of the decrypted image due to unevenness in brightness produced on the encrypted image.

Note that the present invention is by no means limited to the above embodiments. For example, if the reliability of each large block is found, the correction unit may select all of the small blocks located near a small block of interest, as reference value calculation blocks. In this case, upon calculating the statistic to serve as the reference to correct the pixel values in the block of interest, the correction unit uses the values given by multiplying the values of the pixels of a reference value calculation block by a predetermined weighting coefficient. This weighting coefficient assumes a larger value when the reliability of the large block, in which the small block to include the corresponding pixels, has a higher value. Note that a weighting coefficient is a value that is given by, for example, dividing the reliability of each reference value calculation block, by the sum of the reliabilities of all the selected reference value calculation blocks.

An encrypted image that is converted into electronic data by the image input device may be a color image. For example, in the cases where an encrypted image that is converted into electronic data has color information of three colors, namely red (R), green (G) and blue (B), the image decryption apparatuses according to the above embodiments performs the above-described image decryption process with respect to each color.

Alternately, the image decryption apparatus may find the brightness component Y according to the following equations, from the red component, the green component and the blue component, and execute the above-described image decryption process.

Y=0.299R+0.587G+0.114B

U=−0.169R−0.331G+0.500B

V=0.500R−0.419G−0.181B (Equations 5)

However, R, G and B are the values of the red component, the green component, and the blue component, respectively. Also, Y represents the value of the brightness component, and U and V are the values of the chrominance components.

Furthermore, the image decryption apparatus finds the corrected red component R, green component G and blue component B, by converting the corrected brightness component Y and chrominance components U and V, according to the following equations.

R=Y+1.402V

G=Y−0.344U−0.714V

B=Y+1.772U (Equations 6)

A computer program to allow a computer to implement the functions of the processing units of the image decryption apparatus according to the first embodiment or second embodiment may be provided recorded on a computer-readable recording medium such as a magnetic recording medium, optical recording medium, and so on. However, this computer readable recording medium does not include carrier waves.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An image processing apparatus comprising:
an interface unit that acquires an encrypted image that is generated by switching each pixel of an original image, with another pixel of the original image, according to a predetermined rule to indicate a source of move and a destination of move per position conversion block; and
a processor adapted to:
divide the encrypted image into a plurality of first blocks, and, among the plurality of first blocks, specify a first block not presenting unevenness in brightness and a first block presenting unevenness in brightness;
generate a decrypted image by moving each pixel of the encrypted image, from the destination of move to the source of move indicated in the predetermined rule per position conversion block; and
divide the decrypted image into a plurality of second blocks, and, with respect to a block of interest among the plurality of second blocks, selects, from among the second blocks located near the block of interest, at least one second block that is included in the first block not presenting unevenness in brightness on the encrypted image prior to generation of the decrypted image, as a reference value calculation block, and correct a value of each pixel included in the block of interest, using values of pixels included in the reference value calculation block.

2. The image decryption apparatus as claimed in claim 1, wherein, correcting the value of each pixel included in the block of interest comprises correcting values of pixels included in the block of interest such that a statistic of the values of the pixels included in the block of interest matches a reference statistic, which is a statistic of the values of the pixels included in the reference value calculation block.

3. The image decryption apparatus as claimed in claim 1, wherein,
the processor is further adapted to correct values of pixels included in the plurality of first blocks, into which the encrypted image is divided, such that a statistic of the values of the pixels matches between the plurality of first blocks, and
generating the decrypted image comprises generating the decrypted image based on an encrypted image in which the values of pixels included in the plurality of first blocks are corrected such that statistics of the values match.

4. The image decryption apparatus as claimed in claim 1, wherein each of the second blocks is the position conversion block.

5. The image decryption apparatus as claimed in claim 2, wherein,
specifying the first block not presenting unevenness in brightness and the first block presenting unevenness in brightness comprises dividing the encrypted image into the plurality of first blocks, and, for each first block, calculating a degree of reliability which represents the reliability of absence of unevenness in brightness; and
correcting the value of each pixel included in the block of interest comprises calculating a statistic of values given by multiplying the values of pixels included in the reference value calculation block, by a weighting coefficient, which increases when the degree of reliability of the first block on the encrypted image, in which the reference value calculation block is included prior to generation of the decrypted image, is higher, as the reference statistic.

6. The image decryption apparatus as claimed in claim 5, wherein the first block has a size to include a plurality of second blocks.

7. The image decryption apparatus as claimed in claim 5, wherein specifying the first block not presenting unevenness in brightness and the first block presenting unevenness in brightness comprises dividing the encrypted image into the plurality of first blocks, and, when the number of pixels to have a lower pixel value than a predetermined pixel value is smaller, reducing the number of the first blocks to be set in the encrypted image.

8. An image decryption method comprising:
dividing an encrypted image, which is generated by switching each pixel of an original image, with another pixel of the original image, according to a predetermined rule to indicate a source of move and a destination of move per position conversion block, into a plurality of first blocks, and, among the plurality of first blocks, specifying a first block not presenting unevenness in brightness and a first block presenting unevenness in brightness;
generating a decrypted image by moving each pixel of the encrypted image, from the destination of move to the source of move indicated in the predetermined rule per position conversion block; and
dividing the decrypted image into a plurality of second blocks, and, with respect to a block of interest among the plurality of second blocks, selecting, from among the second blocks located near the block of interest, at least one second block that is included in the first block not presenting unevenness in brightness on the encrypted image prior to generation of the decrypted image, as a reference value calculation block; and
correcting a value of each pixel included in the block of interest, using values of pixels included in the reference value calculation block.

9. The image decryption method as claimed in claim 8, wherein, correcting the value of each pixel included in the block of interest comprises correcting values of pixels included in the block of interest such that a statistic of the values of the pixels included in the block of interest matches a reference statistic, which is a statistic of the values of the pixels included in the reference value calculation block.

10. The image decryption method as claimed in claim 8, further comprising correcting values of pixels included in the plurality of first blocks, into which the encrypted image is divided, such that a statistic of the values of the pixels matches between the plurality of first blocks, and wherein
generating the decrypted image comprises generating the decrypted image based on an encrypted image in which the values of pixels included in the plurality of first blocks are corrected such that statistics of the values match.

11. The image decryption method as claimed in claim 8, wherein each of the second blocks is the position conversion block.

12. The image decryption method as claimed in claim 9, wherein,
specifying the first block not presenting unevenness in brightness and the first block presenting unevenness in brightness comprises dividing the encrypted image into the plurality of first blocks, and, for each first block, calculating a degree of reliability which represents the reliability of absence of unevenness in brightness; and
correcting the value of each pixel included in the block of interest comprises calculating a statistic of values given by multiplying the values of pixels included in the reference value calculation block, by a weighting coefficient, which increases when the degree of reliability of the first block on the encrypted image, in which the reference value calculation block is included prior to generation of the decrypted image, is higher, as the reference statistic.

13. The image decryption method as claimed in claim 12, wherein the first block has a size to include a plurality of second blocks.

14. The image decryption method as claimed in claim 12, wherein specifying the first block not presenting unevenness in brightness and the first block presenting unevenness in brightness comprises dividing the encrypted image into the plurality of first blocks, and, when the number of pixels to have a lower pixel value than a predetermined pixel value is smaller, reducing the number of the first blocks to be set in the encrypted image.

15. A computer readable recording medium stored with an image decryption computer program which causes a computer to execute:
dividing an encrypted image, which is generated by switching each pixel of an original image, with another pixel of the original image, according to a predetermined rule to indicate a source of move and a destination of move per position conversion block, into a plurality of first blocks, and, among the plurality of first blocks, specifying a first block not presenting unevenness in brightness and a first block presenting unevenness in brightness;
generating a decrypted image by moving each pixel of the encrypted image, from the destination of move to the source of move indicated in the predetermined rule per position conversion block; and
dividing the decrypted image into a plurality of second blocks, and, with respect to a block of interest among the plurality of second blocks, selecting, from among the second blocks located near the block of interest, at least one second block that is included in the first block not presenting unevenness in brightness on the encrypted image prior to generation of the decrypted image, as a reference value calculation block; and
correcting a value of each pixel included in the block of interest, using values of pixels included in the reference value calculation block.
